(19) United States
(12) Patent Application Publication
(10) Pub. No.: US 2011/0229242 A1
(43) Pub. Date: Sep. 22, 2011

(54) ROLLED PAPER DRIVING APPARATUS AND IMAGE FORMING APPARATUS

(75) Inventors: Shigeru MORINAGA, Kanagawa (JP); Kazuhiro Wakamatsu, Kanagawa (JP); Masahiko Yamada, Tokyo (JP); Takayuki Niihara, Kanagawa (JP); Yuichiro Maeyama, Kanagawa (JP); Masato Ogawa, Kanagawa (JP)

(73) Assignee: RICOH COMPANY, LTD., Tokyo (JP)

(21) Appl. No.: 13/049,090

(22) Filed: Mar. 16, 2011

(30) Foreign Application Priority Data
Mar. 17, 2010 (JP) 2010-060753
Nov. 30, 2010 (JP) 2010-267550

(51) Int. Cl. B41J 15/16

(52) U.S. Cl. 400/613

(57) ABSTRACT

A rolled paper driving apparatus includes supporting rollers that support rolled paper in such a manner that an axis line of the rolled paper extends between the supporting rollers, the rolled paper having a core pipe in a shape of a pile; a driving roller that is pressed onto an inner circumferential surface of the core pipe of the rolled paper and gives force to rotate the rolled paper; a driving force transmission part that rotates the driving roller; and a pressing force adjustment part that adjusts a state of the driving roller being pressed onto the inner circumferential surface of the core pipe of the rolled paper. The driving roller is disposed in the inside of a triangle that has vertexes corresponding to the supporting rollers and a center of the rolled paper, respectively.

### BACKGROUND OF THE INVENTION

1. Field of the Invention

The present invention relates to a rolled paper driving apparatus and an image forming apparatus, and in particular, to a rolled paper driving apparatus that uses rolled paper of paper being rolled on a core pipe, and an image forming apparatus that includes the rolled paper driving apparatus.

2. Description of the Related Art

Recently, in a rolled paper driving apparatus included in a wide format image forming apparatus, it may be necessary to keep appropriate tension and avoid slack otherwise occurring in a paper sheet during conveying the paper sheet, so as to avoid a situation that the paper sheet fed from the rolled paper is fed obliquely or wrinkles occur in the paper sheet. For this purpose, a mechanism may be necessary to transmit driving force to the rolled paper itself in a direction in which the paper sheet is wound onto the rolled paper. A joint such as a spool or a flange may be provided in the core pipe of the rolled paper, rotation of the joint is be maintained, and the joint may be used to transmit driving force to the rolled paper. Thereby, tension is given to the rolled paper, and braking or winding of the paper sheet is carried out in this state.

It is noted that an inner diameter of rolled paper circulating in the market is not standardized, and may be different depending on each manufacturer who manufactures the rolled paper. In consideration of the circumstances, an adapter depending on the inner diameter of the rolled paper may be separately provided, and a function may be provided such that a diameter of a mounting potion of the joint may be changed depending on the inner diameter difference of the rolled paper.

However, in this method, an operation of mounting the joint to the rolled paper is necessary, and thus, workability in mounting the rolled paper to the image forming apparatus may be degraded. Therefore, a driving roller may be directly pressed onto an outer circumferential surface of the rolled paper without using the joint, and driving force may be transmitted to the rolled paper to convey the paper sheet from the rolled paper or wind the paper sheet onto the rolled paper.

Further, in an image forming apparatus such as a label printer which uses lightweight rolled paper, since the rolled paper is lightweight, a driving roller having a diameter smaller than a diameter of a core pipe of the roller paper may be slid and inserted into the core pipe directly, the driving roller may be made to come into contact with the inside of the rolled paper, and driving force may be thus transmitted to the rolled paper (see Japanese Laid-Open Patent Application No. 2008-049670 (Patent Document 2)).

Japanese Laid-Open Patent Application No. 2003-048646 (Patent Document 1) discloses technique in which driving force is directly given to rolled paper without using the joint such as the adaptor, the rolled paper is placed on a driving roller and a pressing roller is used to press the rolled paper to the driving roller. Thereby, it is possible to feed the paper sheet while avoiding slack, and wind the paper sheet without using the joint.

However, when the driving roller is pressed onto the outer circumferential surface of the rolled paper and the rolled paper is rotated by the driving roller, the following problem may occur. That is, when the paper sheet is wound onto the rolled paper, influence of inertia of the rolled paper can be ignored and thus paper sheet can be wound without slack when rotation of the rolled paper is started at low speed. However, when rotation of the rolled paper is started at high speed and then is stopped, inertia of the rolled paper may exceed friction force functioning between paper sheets after the stopping, slack may occur, and thus, winding may not be actually carried out.

Such a situation will now be described with an example of a rolled paper driving apparatus disclosed in Patent Document 1. FIG. 14 diagrammatically shows the rolled paper driving apparatus of Patent Document 1. As shown in FIG. 14, rolled paper 134 is provided between driving rollers 131 and 132. Then, as a result of a pressing roller 133 pressing the rolled paper 134 from the top, driving force is transmitted from the driving rollers 131, 132 to the rolled paper 134 without slip. However, in this configuration, when the driving rollers 131 and 132 are used to wind the paper sheet onto the rolled paper 134, because friction force between the paper sheets is very small, inertia of the rolled paper 134 exceeds the friction, and thus, slack may occur in the rolled paper as shown in FIG. 14. Theoretically, it is possible to carry out winding without slack of the paper sheet when the pressing force of the pressing roller is sufficiently large. However, by such large pressing force, damage may occur in the outer circumferential surface of the rolled paper 134 on which printing is carried out.

### SUMMARY OF THE INVENTION

According to an embodiment of the present invention, a rolled paper driving apparatus includes supporting rollers, disposed on a base, which support rolled paper of paper being rolled on a core pipe, in such a manner that an axis line of the rolled paper extends between the supporting rollers; a driving roller that is pressed onto an inner circumferential surface of the core pipe of the rolled paper and gives force to rotate the rolled paper; a driving force transmission part that rotates the driving roller; and a pressing force adjustment part that adjusts a state of the driving roller being pressed onto the inner circumferential surface of the core pipe of the rolled paper. The driving roller is disposed in the inside of a triangle that has vertexes respectively corresponding to the supporting rollers and a center of the rolled paper.

Other objects, features and advantages of the present invention will become more apparent from the following detailed description when read in conjunction with the accompanying drawings.

### BRIEF DESCRIPTION OF THE DRAWINGS

FIG. 1 shows a general configuration of an image forming apparatus according to an embodiment 1;

FIG. 2 shows a perspective view of a rolled paper driving apparatus according to the embodiment 1;

FIG. 3 shows a side view of the rolled paper driving apparatus according to the embodiment 1;

FIG. 4 shows a front view of the rolled paper driving apparatus according to the embodiment 1 and shows a procedure of setting rolled paper in the rolled paper driving apparatus;

FIG. 5 diagrammatically shows a driving system of the rolled paper driving apparatus according to the embodiment 1;

FIG. 6 diagrammatically shows a state of a driving roller and first and second supporting rollers at a time of a paper sheet being pulled out in the rolled paper driving apparatus according to the embodiment 1;

FIG. 7 diagrammatically shows a state of the driving roller and the first and second supporting rollers at a time of the paper sheet being wound in the rolled paper driving apparatus according to the embodiment 1;

FIGS. 8, 9 and 10 show a front view of the rolled paper driving apparatus according to the embodiment 1 and show a procedure of setting the rolled paper in the rolled paper driving apparatus;

FIG. 11 diagrammatically shows a position relationship between the driving roller and the first and second supporting rollers in a rolled paper driving apparatus according to an embodiment 2;

FIG. 12 shows a control system of the rolled paper driving apparatus according to the embodiment 2;

FIG. 13 shows a position relationship between the driving roller and the first and second supporting rollers in a rolled paper driving apparatus according to an embodiment 3; and

FIG. 14 shows a case where a driving roller transmits driving force to an outer circumferential surface of rolled paper in the related art.

### DETAILED DESCRIPTION OF THE EMBODIMENTS

According to an embodiment of the present invention, an outer circumferential surface of rolled paper is supported by supporting rollers, and a driving roller is pressed onto an inner circumferential surface of a core pipe of the rolled paper. As a result, it is possible to provide a rolled paper driving apparatus and an image forming apparatus in which even in a case of a braking or winding operation in intermittent conveyance, the rolled paper can be conveyed without slack.

A rolled paper driving apparatus according to an embodiment of the present invention includes two sets of supporting rollers that support rolled paper of paper being rolled onto a core pipe in such a manner that an axis line of the rolled paper extends between the two sets of the supporting rollers. The rolled paper driving apparatus further includes a driving oiler that is pressed onto and gives rotation driving force to the rolled paper, and a driving force transmission part that rotates the driving roller. The rolled paper driving apparatus further includes a pressing force adjustment part that adjusts a state of the driving roller being pressed onto the core pipe of the rolled paper. The driving roller is disposed on an inner circumferential surface of the core pipe and disposed at a position in the inside of a triangle having vertexes that respectively correspond to the two sets of supporting rollers and a center of the rolled paper.

In this configuration, driving force is transmitted from the inside of the core pipe of the rolled paper. Thereby, it is possible to carry out a paper winding operation without causing slack of a paper sheet. Further, the driving roller is provided in the inside of the triangle having the vertexes respectively corresponding to the two sets of supporting rollers and the center of the rolled paper. Thereby, when the paper sheet is pulled out from the rolled paper, the rolled paper is not easily lifted from the supporting rollers.

Further, the driving roller of the rolled paper driving apparatus is inserted into an opening portion of the core pipe from one side, and a pressing roller is inserted into the opening portion of the core pipe from the other side. The pressing roller is inserted into the opening portion in such a manner to come into contact with the inner circumferential surface of the core pipe and gives force to the rolled paper. In this configuration, the driving roller and the pressing roller are inserted into the opening portion of the core pipe from both sides, and thus, the force is given to the rolled paper by the driving roller and the pressing roller stably. Further, it is possible to prevent the rolled paper from becoming oblique and thus, conveyance of paper can be stably carried out.

Further, the rolled paper driving apparatus according to an embodiment includes a moving part that moves at least one of the driving roller and the pressing roller in a direction in which the axis line of the rolled paper extends. When the rolled paper is set in the rolled paper driving apparatus, the rolled paper is moved for a distance corresponding to a width (i.e., a length) of the driving roller. According to the embodiment, the rolled paper can be set in the rolled paper driving apparatus by moving the driving roller or the pressing roller.

Further, in the rolled paper driving apparatus according to an embodiment, the pressing force adjustment part includes a force giving part that gives pressing force, and a giving force changing mechanism that adjusts the pressing force of the force giving part and allows the driving roller and the pressing roller to be apart from the core pipe. According to the embodiment, since it is possible to allow the driving roller and the pressing roller to be apart from the core pipe, it is possible to easily set the rolled paper in the rolled paper driving apparatus. Further, it is possible to adjust the force to be given to the rolled paper.

Further, according to an embodiment, the force giving part has springs provided for the driving roller and the pressing roller, respectively, and the giving force changing mechanism has cam members that change force given by the springs, a shaft member that links the cam members together, an operation arm that is used to change attitudes of the cam members. According to the embodiment, the respective cam members for the driving roller and the pressing roller which press both ends of the rolled paper are linked together to interlock, and thus, the cam members can be operated with the operation arm. Therefore, it is possible to simultaneously adjust the driving roller and the pressing roller or simultaneously allow the driving roller and the pressing roller to be apart from the rolled paper.

Further, in the rolled paper driving apparatus according to an embodiment, the driving roller and the pressing roller are disposed on arm members that are disposed at both end portions of the base in such a manner that the rolled paper is inserted between the arm members. The arm members are disposed on the base rotatably with respect to the base, and at least one of the arm members is movable in the direction in which the axis line of the rolled paper extends. According to the embodiment, the driving roller and the pressing roller disposed on the arm members press both ends of the rolled paper. Thereby, the rolled paper is prevented from being oblique, and thus, the paper sheet can be stably conveyed from the rolled paper.

Further, in a rolled paper driving apparatus according to an embodiment, a driving roller position changing part that supports the driving roller in such a manner that the position of the driving roller is changeable in the inside of the triangle is provided. Further, a detection part that detects a rotation direction of the rolled paper, and a driving roller position control part that drives the driving roller position changing part based on a detection result of the detection part, and disposes a position at which the driving roller comes into contact with the core pipe to an end of the core pipe on a downstream side in the inside of the triangle. According to the embodiment, it is possible to change a position of the driving roller to an optimum position in response to a paper sheet being pulled out from the rolled paper or the paper sheet being wound onto the rolled paper.

Further, in the rolled paper driving apparatus according to an embodiment, a toque limiter is provided between the driving roller and prime mover that drives the driving roller. The torque limiter transmits torque from the prime mover to the driving roller but avoid transmitting torque equal to or more than a predetermined value. According to the embodiment, excessively large torque is prevented from being given to the driving roller, and it is possible to give appropriate driving force and braking force.

Further, an image forming apparatus according to an embodiment includes any one of the above-mentioned rolled paper driving apparatuses.

Embodiments of the present invention will be described in more details with reference to figures.

### Embodiment 1

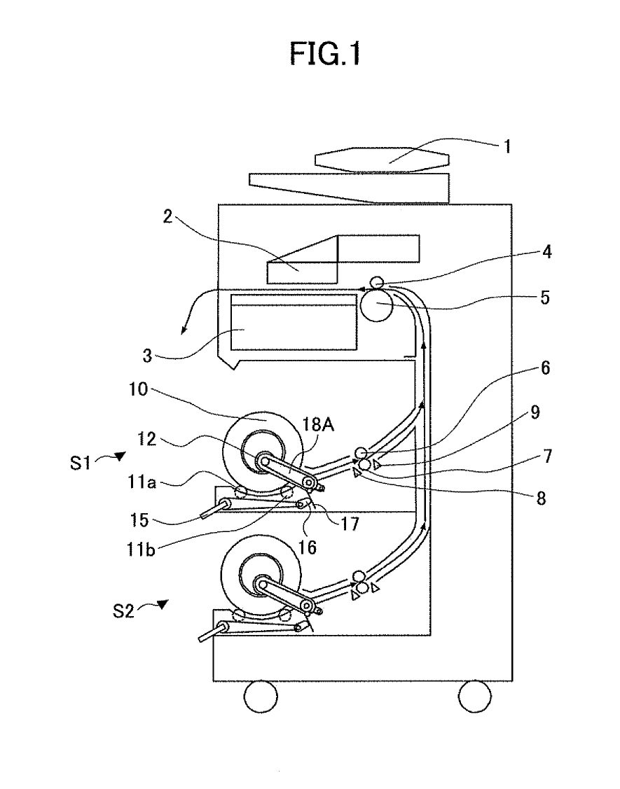

Below, an image forming apparatus according to an embodiment 1 will be described. FIG. 1 shows a general configuration of the image forming apparatus according to the embodiment 1. The image forming apparatus according to the embodiment 1 includes two rolled paper feeding stages S1, S2 as shown in FIG. 1 and two sets of rolled paper 10 are set from the front side of the image forming apparatus. A paper sheet pulled out from the rolled paper 10 in the upper one S1 of the two rolled paper feeding stages S1, S2 is sandwiched by a paper feeding roller 6 and a paper feeding pressing roller 7, and is fed to a conveyance roller 5 and a pressing roller 4 provided above a paper feeding part (including the two rolled paper feeding stages S1, S2). At this time, a driving roller 12 is rotated in such a direction to feed the paper sheet from the rolled paper 10, and gives braking force to the rolled paper 10 for preventing the rolled paper 10 from being rotated excessively. The paper sheet is fed to a horizontal conveyance part 3, and as a result of an image forming part 2 discharges ink, printing is carried out, i.e., an image is formed on the fed paper sheet. The image formed by the image forming part 2 is an image read by an image reading part 1 or an image transmitted from an electronic information device or such (not shown).

After the image is thus formed on the paper sheet, the conveyance roller 5 and the paper feeding roller 6 are rotated in reverse, and the paper sheet is withdrawn backward. At this time, driving force is transmitted from the driving roller 12 to the rolled paper 10, the rolled paper 10 is thus rotated in reverse, and a front end portion of the paper sheet is withdrawn backward up to the conveyance roller 5. It is noted that when a paper feeding source is switched to the lower rolled paper feeding stage S2, the front end portion of the paper, having been fed from the upper rolled paper feeding stage S1 as mentioned above, is withdrawn backward up to the paper feeding roller 6.

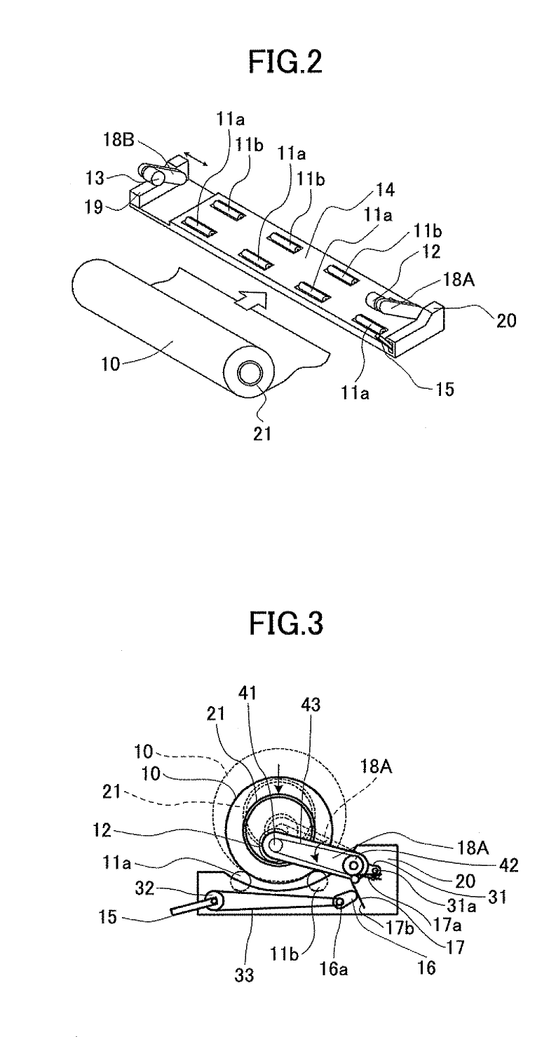

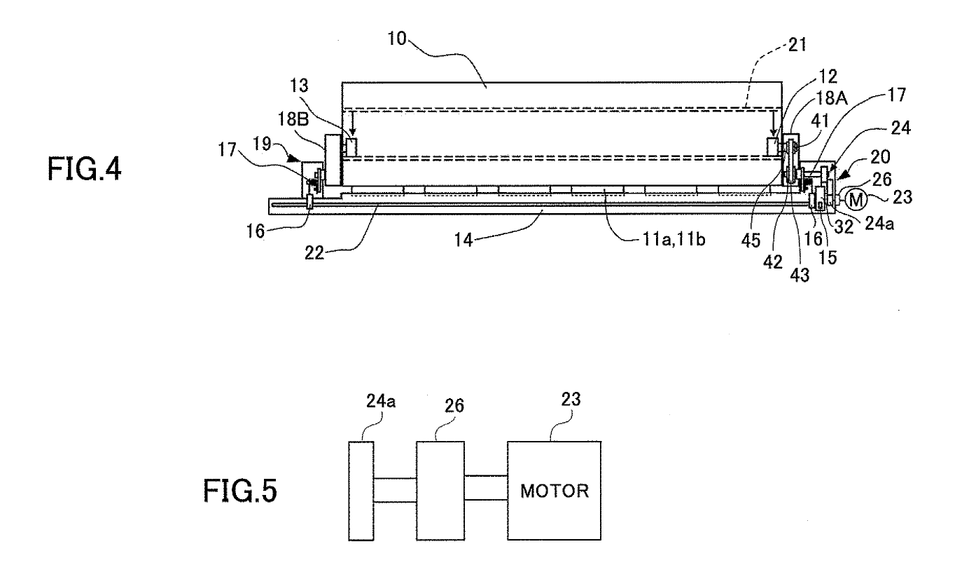

FIG. 2 shows a perspective view of a rolled paper driving apparatus according to the embodiment 1, FIG. 3 shows a side view of the rolled paper driving apparatus according to the embodiment 1, and FIG. 4 shows a front view of the rolled paper driving apparatus according to the embodiment 1. The rolled paper driving apparatus according to the embodiment includes a paper feeding stay 14 that is a base, and four first supporting rollers 11a and four second supporting rollers 11b on which the rolled paper 10. The first and second supporting rollers 11a and 11b are rotatably disposed on the paper feeding stay 14. The first and second supporting rollers 11a and 11b are disposed so that the four first supporting rollers 11a support a front side portion (i.e., a left side portion in FIG. 3) of a bottom side portion of the rolled paper 10 and the four second supporting rollers 11b support a rear side portion (i.e., a right side portion in FIG. 3) of the bottom side portion of the rolled paper 10.

Further, a driving transmission part 20 is provided to stand on the paper feeding stay 14 at one end of the rolled paper 10 in directions (i.e., left and right directions in FIG. 4) in which a rotation axis of the rolled paper 10 extends. A pressing holder 19 is provided to stand on the paper feeding stay 14 at the other end of the rolled paper 10 in the directions in which the axis line of the rolled paper 10 extends. The pressing holder 19 is disposed slidably with respect to the paper feeding tray 14, and is movable forward and backward in the directions along the rotation axis of the rolled paper 10.

To the driving transmission part 20, a driving side pressing arm 18A that is an arm member is provided to extend and is rotatable about a portion at which the driving side pressing arm 18A is connected to the driving transmission part 20, and the driving roller 12 is disposed at the extending end portion of the driving side pressing arm 18A.

In the pressing holder 19, a pressing side pressing arm 18B that is another arm member is provided to extend and is rotatable about a portion at which the pressing side pressing arm 18B is connected to the pressing holder 19, and a pressing roller 13 is disposed at the extending end portion of the pressing side pressing arm 18B.

The surface of the driving roller 12 is coated by a material having a high coefficient of friction, for example, rubber, ceramic, or such. The driving roller 12 is driven and rotated by a motor 23 that is operated to rotate forwardly and reversely, and transmits the driving force to a core pipe 21 of the rolled paper 10 while coming into contact with an inner circumferential surface of the core pipe 21 without slip. The driving force of the motor 23 is transmitted to the driving roller 12 by means of the driving transmission part 20 that includes a driving force transmission mechanism 24 disposed for the driving side pressing arm 18A.

According to the embodiment 1, a gear transmission mechanism is used as the driving force transmission mechanism 24, and a belt winding transmission mechanism is provided in the driving side pressing arm 18A. That is, the driving force of the motor 23 is transmitted to a base end pulley 42 supported by the base end portion of the driving side pressing arm 18A by means of the gear transmission mechanism of the driving force transmission mechanism 24. Then, the transmission force is transmitted from the base end pulley 42 to an extending end pulley 41 supported by the extending end portion of the driving side pressing arm 18A via a transmission belt 43 wound between these pulleys 42 and 41. The pulleys 41, 42 and the transmission belt 43 are included in the above-mentioned belt winding transmission mechanism. The driving force thus transmitted to the extending end pulley 41 is then transmitted to the driving roller 12 via a shaft 45 that connects the extending end pulley 41 and the driving roller 12.

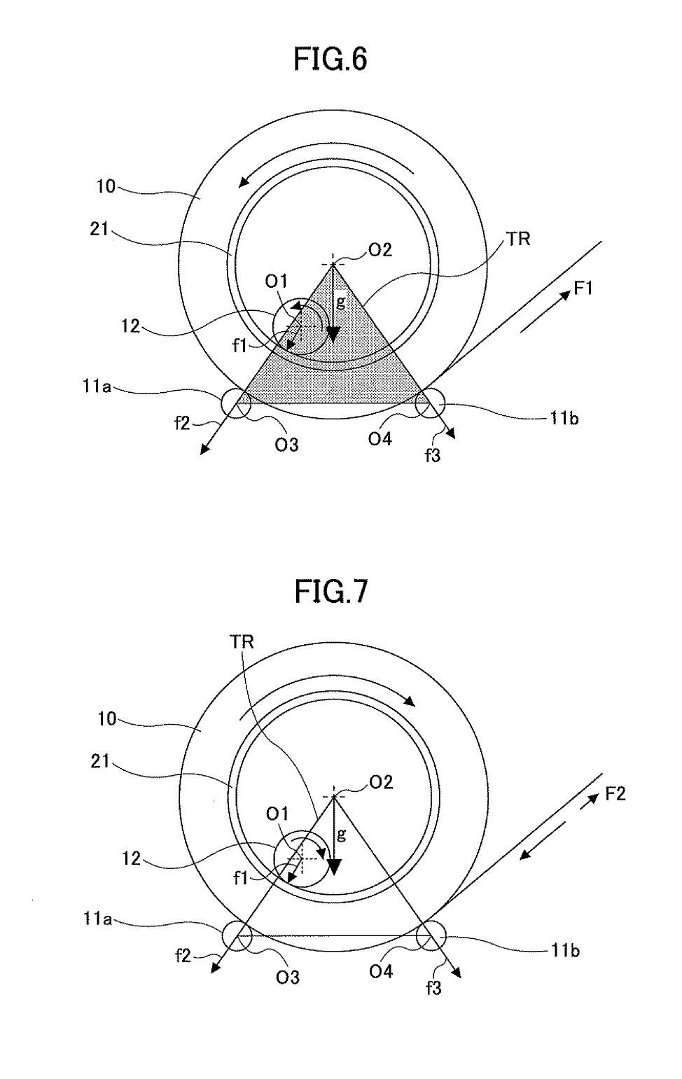

Further, the driving roller 12 is configured to have a small diameter such that the driving roller 12 can be disposed in the inside of the core pipe 21, and the width (i.e., the length) of the driving roller 12 is smaller than the width (i.e., the length) of the rolled paper 10. Further, according to the embodiment 1, the driving roller 12 is disposed at a position approaching the side of the first supporting rollers 11a with respect to the center position between the first supporting rollers 11a and the second supporting rollers 11b (see FIGS. 6 and 7).

Further, for the driving force transmission mechanism 24, a torque limiter 26 is disposed to avoid transmitting torque equal to or more than a predetermined value. As shown in FIG. 5, the torque limiter 26 is disposed between the motor 23 and a gear 24a of a first stage in the gear transmission mechanism of the driving force transmission mechanism 24. The torque limiter 26 absorbs a difference between the rotation of the driving roller 12 coming into contact with the rolled paper 10 and the rotation of the motor 23, by avoiding transmission of driving force equal to or more than the predetermined value. As the torque limiter 26, it is possible to use a torque limiter of a well-known mechanical, hydraulic or electric type, and the upper limit of the torque limiter is set such that the rolled paper 10 can be prevented from being rotated excessively and falling down from the first supporting rollers 11a and the second supporting rollers 11b at a time of winding (i.e., withdrawing) the paper sheet onto or a time of pulling out the paper sheet from the rolled paper 10.

The surface of the pressing roller 13 is coated the same as the above-mentioned coating of the surface of the driving roller 12. The pressing roller 13 is driven and rotated by the core pipe 21 of the rolled paper 10 that is driven and rotated by the driving roller 12 while pressing the inner circumferential surface of the core pipe 21 of the rolled paper 10. The pressing roller 13 is configured to have a small diameter such that the pressing roller 12 can be disposed in the inside of the core pipe 21, and the width (i.e., the length) of the pressing roller 13 is smaller than the width (i.e., the length) of the rolled paper 10.

Further, the extending portion 17a of each of helical torsion coil springs 17 is connected to a protrusion 31a formed on an extending arm 31 fixed to the base end portion of a respective one of the driving side pressing arm 18A and the pressing side pressing arm 188 (see FIG. 3, and the helical torsion coil spring 17 connected to the pressing side pressing arm 18B being omitted in FIG. 3). Thereby, such force is given to the driving side pressing arm 18A and the pressing side pressing arm 18B that the driving roller 12 and the pressing roller 13 press the core pipe 21 of the rolled paper 10 downward, as will be described later. Respective pressing cams 16 come into contact with the other extending portion 17b the respective ones of the helical torsion coil springs 17. As a result of the pressing cams 16 being rotated, the force given to the driving side pressing arm 18A and the pressing side pressing arm 18B by the helical torsion coil springs 17 is adjusted, and also, the driving roller 12 and the pressing roller 13 are allowed to be apart from the core pipe 21, as will be described later.

As shown in FIG. 3, the helical torsion coil spring 17 has two extending portions 17a and 17b, and the helical torsion coil spring 17 provides the elastic force to cause an angle formed by the two extending portions 17a and 17b to increase. Since the extending portion 17b is pressed by the pressing cam 16, the other extending portion 17a presses the protrusion 31a formed on the extending arm 31 fixed to the base end portion of the driving side pressing arm 18A. Thereby, the force is given to the driving side pressing arm 18A to rotate counterclockwise about the above-mentioned portion at which the driving side pressing arm 18A is rotatably connected to the driving transmission part 20. Thus, the force is given to the driving side pressing arm 18A such that the driving roller 12 provided at the extending end portion of the pressing side pressing arm 18A is pressed onto the inner circumferential surface of the core pipe 21.

Further, an operation lever 15 is connected to the pressing cam 16, of the two pressing cams 16, provided for the driving side pressing arm 18A. Thereby, the force given by the helical torsion coil springs 17 can be adjusted with the operation lever 15 via the pressing cams 16. It is noted that the two pressing cams 16 are provided for the respective ones of the driving side pressing arm 18A and the pressing side pressing arm 18B correspondingly at the different positions (the pressing cam 16 provided for the pressing side pressing arm 18B being omitted in FIG. 3). The two pressing cams 16 are linked together by a shaft 22 that is a shaft member, and thereby, the two pressing cams 16 interlock.

As shown in FIG. 3, the operation lever 15 is fixed to an operation pulley 32 and an operation carried out to the operation level 15 is transmitted to a driving pulley 16a fixed to the pressing cam 16 via a transmission belt 33 wound between these pulleys 32 and 16a. In this configuration, when the user rotates the operation lever 15, this operation is transmitted to the pressing cam 16a via a belt winding transmission mechanism including the pulleys 33, 16a and the belt 33. As a result, the pressing cam 16 is rotated, and thus, the attitude of the pressing cam 16 changes. Since the two pressing cams 16 are linked by the shaft 22, the two pressing cams 16 have the same attitudes. As a result of the change in the attitudes of the pressing cams 16, the pressing force given by the pressing cams 16 to the extending portions 17b of the helical torsion coil springs 17 change, respectively. Thereby, the force given by the other extending portions 17a of the helical torsion coil springs 17 are adjusted, respectively, and thus, the pressing force of the driving roller 12 and the pressing roller 13 onto the inner circumferential surface of the core pipe 21 is adjusted.

Then, when the user operates the operation lever 15 to reduce or remove the pressing force of the driving roller 12 and the pressing roller 13 onto the inner circumferential surface of the core pipe 21, the driving roller 12 and the pressing roller 13 are allowed to be apart from the core pipe 21.

It is noted that a distance by which the pressing holder 19 slides on the paper feeding stay 14 is made longer than a length obtained from adding the width (i.e., the length) of the driving roller 12 and the width (i.e., the length) of the pressing roller 13 together. As a result, the rolled paper 10 can be disposed between the driving roller 12 and the pressing roller 13 in a state that the pressing holder 19 has been slid. Instead of the above-mentioned configuration that the pressing holder 19 is slidable with respect to the paper feeding stay 14 so as to move the pressing roller 13 in the directions of the rotation axis of the rolled paper 10, a configuration may be provided that the driving transmission part 20 is slidable with respect to the paper feeding stay 14 so as to move the driving roller 12 in the directions of the rotation axis of the rolled paper 10, or a configuration may be provided that both the pressing holder 19 and the driving transmission part 20 are slidable with respect to the paper feeding stay 14 so as to move the driving roller 13 and/or the pressing roller 13 in the directions of the rotation axis of the rolled paper 10, for the purpose of easily replacing the rolled paper 10.

In the rolled paper driving apparatus, the core pipe 21 of the rolled paper 10 is pressed downward by the driving roller 12 that is driven and rotated by the motor 23, also the core pipe 21 is pressed downward by the pressing roller 13, the rolled paper 10 is supported by the first supporting rollers 11a and the second supporting rollers 11b, and the paper sheet is pulled out from and is wound onto the rolled paper 10. Further, as the paper sheet is used and consumed, the outer diameter of the rolled paper 10 is reduced, and thus, the rolled paper 10 moves downward accordingly in the rolled paper driving apparatus. According to the embodiment 1, the driving roller 12 and the pressing roller 13 follow the rolled paper 10 and move correspondingly while coming into contact with the inner circumferential surfaces of the core pipe 21. Thus, the pressing force and the driving force of the driving roller 12 are effectively transmitted to the rolled paper 10.

Next, the driving roller 12, the first supporting rollers 11a and the second supporting rollers 11b will be described in detail. FIG. 6 diagrammatically shows a state of the driving roller 12, the first supporting rollers 11a and the second supporting rollers 11b of the rolled paper driving apparatus according to the embodiment 1 at the time of the paper sheet being pulled out from the rolled paper 10. FIG. 7 diagrammatically shows a state of the driving roller 12, the first supporting rollers 11a and the second supporting rollers 11b of the rolled paper driving apparatus according to the embodiment 1 at the time of the paper sheet being wound onto the rolled paper 10. It is noted that to the pressing roller 13 only the pressing force is given, and therefore, description will now be made only for the driving roller 12.

The first supporting rollers lie and the second supporting rollers 11b are disposed in front of and in back of the rolled paper 10, and a distance between the respective centers O3 and O4 of the first supporting rollers lie and the second supporting rollers 11b is shorter than the diameter of the core pipe 21. Further, the center O1 of the driving roller 12 is disposed in the inside of a triangle TR having respective vertexes corresponding to the center O2 of the rolled paper 10, the center O3 of the first supporting rollers 11a, the center O4 of the second supporting rollers 11b, and approaches the first supporting rollers 11a with respect to the center position between the first supporting rollers 11a and the second supporting rollers 11b. Further, the driving roller 12 presses the inner circumferential surface of the core pipe 21 by predetermined pressing force f1, and also, is driven and rotated by torque controlled by the torque limiter 26 to be equal to or less than the predetermined value. According to the embodiment 1, by this configuration, the rolled paper 10 stably operates when the paper sheet is pulled out from and is wound onto the rolled paper 10.

The time of pulling out the paper sheet from the rolled paper 10 will now be described. As shown in FIG. 6, when the paper sheet is pulled out from the rolled paper 10 by the conveyance roller 5 and the paper feeding roller 6 (see FIG. 1), the load g of the rolled paper 10, tensile force F1 of the paper sheet being pulled out and the pressing force f1 by the driving roller 12 are given to the rolled paper 10. It is noted that the rolled paper 10 is then rotated as a result of the paper sheet being pulled from the rolled paper 10 by the conveyance roller 5 and the paper feeding roller 6. Further, the rotation force is given to the driving roller 12 from the motor 23 via the torque limiter 26 to follow the rotation of the core pipe 21 without slip.

Then, the force given to the rolled paper 10 is supported by reaction force f2 given by the first supporting rollers 11a and reaction force f3 given by the second supporting rollers 11b. At this time, when the tensile force F1 of the paper sheet being pulled increases and the circumferential speed of the core pipe 21 of the rolled paper 10 becomes higher than the circumferential speed of the driving roller 12, the rolled paper 10 would move over the first supporting rollers 11a and fall down. However, according to the embodiment 1, the driving roller 12 is disposed in the inside of the triangle TR and also is pressed toward the outside of the core pipe 21 by the pressing force f1. Therefore, the driving roller 12 is prevented from being lifted and rotates stably.

Further, according to the embodiment 1, the torque limiter 26 is disposed for the driving roller 12. Therefore, when the driving roller 12 follows the core pipe 21 to rotate, the respective circumferential speeds of the driving roller 12 and the core pipe 21 are prevented from becoming different. At this time, slip occurs between the driving roller 12 and the motor 23 by the torque limiter 26. As a result, the driving roller 12 gives moderate braking force to the core pipe 21. Thereby, at a time of an intermittent operation of the paper sheet being pulled out from the rolled paper 10, slack of the paper sheet pulled out from the rolled paper 10 is avoided, and also the rolled paper 10 smoothly rotates to feed the paper sheet without falling down to the side of the first supporting rollers 11a.

Next, the time of winding the paper sheet onto the rolled paper 10 will be described. When the paper sheet is wound onto the rolled paper 10, as shown in FIG. 7, the load g of the rolled paper 10, the tensile resistance force F2 given by the paper sheet and the pressing force f1 given by the driving roller 12 are given to the rolled paper 10. Further, to the driving roller 12, driving force is given from the motor 23 via the torque limiter 26 for rotating the core pipe 21.

The force thus given to the rolled paper 10 is supported by reaction force f2 given by the first supporting rollers 11a and reaction force f3 given by the second supporting rollers 11b. At this time, when the circumferential speed of the driving roller 12 becomes higher than the circumferential speed of the core pipe 21 of the rolled paper 10, the rolled paper 10 would move over the second supporting rollers 11b and fall down. However, according to the embodiment 1, the driving roller 12 is disposed in the inside of the triangle TR, and is pressed toward the outside of the core pipe 21 by the force f1. Therefore, the rolled paper 10 is prevented from being lifted and rotates stably. Further, even when the circumferential speed of the core pipe 21 becomes different from the circumferential speed of the driving roller 12, the driving roller 12 follows the core pipe 21 to rotate since the torque limiter 26 is provided for the driving roller 12.

At this time, slip occurs between the driving roller 12 and the motor 23 by the torque limiter 26, and thus, the driving roller 12 gives moderate braking force to the core pipe 21. Thereby, when the paper sheet is wound onto the rolled paper 10, the rolled paper 10 does not cause slack in the paper sheet, and the rolled paper 10 smoothly rotates without moving over the second supporting rollers 11b and falling down and has the paper sheet wound onto the rolled paper 10.

It is noted that the magnitude of the pressing force f1 is set through calculation or experiment so as to prevent the rolled paper 10 from falling down at the time of pulling out and at the time of winding of the paper sheet, depending on the size and mass of the rolled paper 10, the speed of the paper sheet being pulled out, the distance between the first supporting rollers 11a and the second supporting rollers 11b, and the position of the driving roller 12. Generally speaking, it is advantageous to dispose the driving roller 12 to the downstream side of the rotation direction of the rolled paper within the core pipe 21 from the viewpoint of avoiding falling dawn of the rolled paper 10.

According to the embodiment 1, the driving roller 12 is disposed to the downstream side of the time of winding the paper sheet onto the rolled paper 10 within the core pipe 21. Therefore, assuming that the rotation speed of the rolled paper 10 is fixed, pressing force fw required for avoiding falling down of the rolled paper 10 at the time of winding is to be larger than pressing force fp required for avoiding falling down of the rolled paper 10 at the time of pulling out. However, in both cases, the pressing force may be the pressing force fw of the time of pulling out. Therefore, according to the embodiment 1, the above-mentioned force f1 is determined to be the pressing force fp required for avoiding falling down of the rolled paper 10 at the time of pulling out.

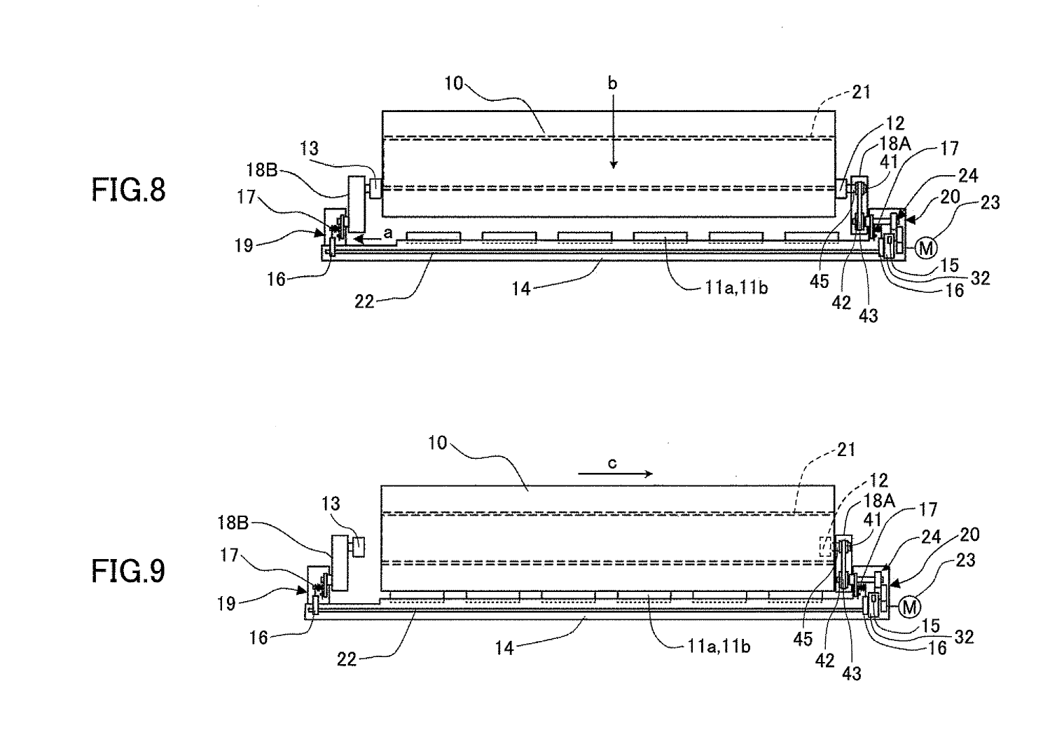

Next, setting of the rolled paper 10 will be described. FIGS. 8, 9 and 10 show a front view of the rolled paper driving apparatus and show a procedure of setting the rolled paper 10 into the rolled paper driving apparatus according to the embodiment 1. First, the operation lever 15 is operated by the user so that such a state is provided to allow the driving roller 12 and the pressing roller 13 to be apart from the core pipe 21. After that, as shown in FIG. 8, the pressing roller 13 is pulled toward the outside of the paper feeding stay 14 (i.e., in a direction of an arrow “a” shown in FIG. 8). Next, the rolled paper 10 is disposed between the driving roller 12 and the pressing roller 13 (i.e., in a direction of an arrow “b” shown in FIG. 8), and thus, is set on the first supporting rollers 11a and the second supporting rollers 11b.

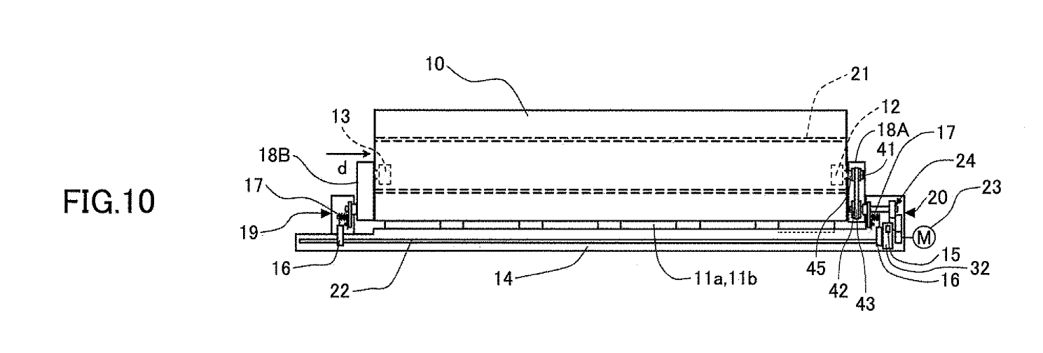

Next, as shown in FIG. 9, the rolled paper 10 is moved laterally (i.e., in a direction of an arrow “c” shown in FIG. 9) so that the driving roller 12 is inserted into the inside of the core pipe 21. Then, as shown in FIG. 10, the pressing holder 19 is slid (i.e., in a direction of an arrow “d” shown in FIG. 10), and thus, the pressing roller 13 is disposed into the inside of the core pipe 21. When this operation of sliding the pressing holder 19 is carried out by the user, since the pressing cam 16 and the helical torsion coil spring 17 are disposed in the pressing holder 19, the pressing cam 16 and the helical torsion coil spring 17 are moved together simultaneously.

Then, the user operates the operation lever 15, and carries out adjustment such that the driving roller 12 and the pressing roller 13 are caused to come into contact with the inner circumferential surface of the core pipe 21 and press the inner circumferential surface of the core pipe 21 by predetermined force. Thus, the setting of the rolled paper 10 is finished in the state that the driving roller 12 and the pressing roller 13 come into contact with the inner circumferential surface of the core pipe 21. It is noted that, in this state, spring force of the helical torsion coil springs 17 is given to the driving roller 12 and the pressing roller 13, respectively, by the pressing cams 16. As mentioned above, the left and right pressing cams 16 are linked together by the shaft 22. Therefore, when the user operates the operation lever 15, the driving roller 12 and the pressing roller 13 are caused to come into contact with and are pressed onto a bottom side portion of the inner circumferential surface of the core pipe 21.

Thus, according to the embodiment 1, replacement of the rolled paper 10 can be easily carried out, and further, it is not necessary to provide a special member even when the rolled paper 10 of a different type having a different size is set.

Further, as is necessary, driving force generated by the motor 23 is transmitted to the driving roller 12 via the driving force transmission mechanism 24, and thus, operations, such as feeding the paper sheet from the rolled paper 10, winding the paper sheet onto the rolled paper 10 and stopping the operation, can be carried out. Therefore, in the rolled paper driving apparatus according to the embodiment 1, it is possible to convey the paper sheet without slack even in the braking operation or the winding operation at the time of intermittent conveyance of the paper sheet.

It is noted that according to the embodiment 1, the driving roller 12 is disposed near the first supporting rollers 11a. However, it is also possible to provide a configuration that the driving roller 12 is disposed near the second supporting rollers 11b. Also in this case, the torque to be set in the torque limiter 26 and the pressing force of the driving roller 12 to be given to the core pipe 21 are determined depending on actual operation conditions.

### Embodiment 2

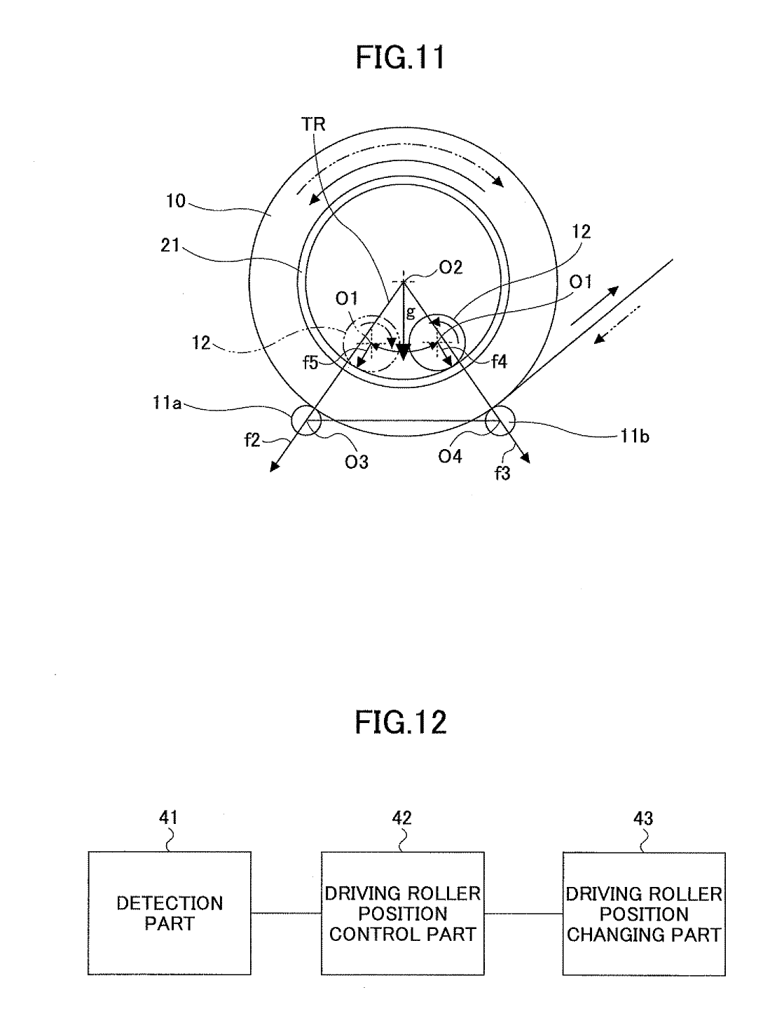

Next, a rolled paper driving apparatus according to an embodiment 2 of the present invention will be described. The rolled paper driving apparatus according to the embodiment 2 is almost the same as the rolled paper driving apparatus according to the embodiment 1 described above, and thus, different points will be described and duplicate description will be appropriately omitted. In the rolled paper driving apparatus according to the embodiment 2, the driving roller 12 is moved to optimum positions at the time of winding of the paper sheet onto the rolled paper 10 and at the time of pulling out the paper sheet from the rolled paper 10. FIG. 11 diagrammatically shows a position relationship between the driving roller 12 and the first and second supporting rollers 11a, 11b in the rolled paper driving apparatus according to the embodiment 2. FIG. 12 shows a block diagram of a control system of the rolled paper driving apparatus according to the embodiment 2.

According to the embodiment 2, as shown in FIG. 12, the rolled paper driving apparatus includes a detection part 41, a driving roller position changing part 42 and a driving roller position control part 43. The detection part 41 detects a rotation direction of the rolled paper 10. The driving roller position changing part 42 changes a position of the driving roller 12 coming into contact with the inner circumferential surface of the core pipe 21 within the above-mentioned triangle TR. The driving roller position control part 43 drives the driving roller changing part 42 based on a detection result of the detection part 41 and sets the position of the driving roller 11 coming into contact with the inner circumferential surface of the core pipe 21 to an end portion of the core pipe 21 on the downstream side in the inside of the triangle TR.

The driving roller changing part 42 is a mechanism that changes the position of the driving roller 12 coming into contact with the inner circumferential surface of the core pipe 21 under the control of the driving roller position control part 43. That is, at the time of feeding (i.e., pulling out) the paper sheet from the rolled paper 10, the driving roller changing part 42 disposes the driving roller 12 (indicated by the solid lines in FIG. 11) on the downstream side of the rotation direction of the core pipe 21 (i.e., counterclockwise in FIG. 11), i.e., near the second supporting rollers 11b in the inside of the triangle TR. Then, the driving roller changing part 42 causes the driving roller 12 to press the core pipe 21 by pressing force f4.

At the time of winding the paper sheet onto the rolled paper 10, the driving roller changing part 42 disposes the driving roller 12 (indicated by the dash-dot-dot lines in FIG. 11) on the downstream side of the rotation direction of the core pipe 21 (i.e., clockwise in FIG. 11), i.e., near the first supporting rollers lie in the inside of the triangle TR. Then, the driving roller changing part 42 causes the driving roller 12 to press the core pipe 21 by pressing force f5. In any one of both cases (i.e., the cases of the solid lines and the dash-dot-dot lines), the driving roller 12 is driven and rotated in the predetermined direction, i.e., counterclockwise or clockwise, by the motor 23 via the torque limiter 26.

The driving roller position changing part 42 swings the driving roller 12 between the position near the first supporting rollers 11a and the position near the second supporting rollers 11b, as shown in FIG. 11, and further, causes the driving roller 12 to press the inner circumferential surface of the core pipe 21. The driving roller position changing part 42 may be configured by a well-known mechanism (not shown) including an arm member that swings the driving roller 12 and a mechanism that causes the driving roller 12 to come into contact with and be apart from the inner circumferential surface of the core pipe 21. It is noted that as the above-mentioned force fp for the pressing force f4 at the time of pulling out and as the above-mentioned force fw for the pressing force f5 at the time of winding, the values are set which are optimum to the operation conditions.

Further, the driving roller position control part 43 drives the driving roller changing part 42 based on the signal from the detection part 41. As the deriving roller position control part 43, an electric motor, an electromagnetic solenoid or a hydraulic mechanism may be used. By driving this, the position of the driving roller 12 is changed by using the driving roller position changing part 42. It is noted that operations of the rolled paper driving apparatus according to the embodiment 2 to be carried out when, for example, the rolled paper 10 is replaced, are the same as those of the rolled paper driving apparatus according to the embodiment 1.

According to the embodiment 2, the position of the driving roller 12 is changed at the time of winding and at the time of puling out. Thereby, it is possible to dispose the driving roller 12 to the optimum position to avoid falling down of the rolled paper 10 at any one of the corresponding conditions of winding and puling out, and cause the rolled paper 10 to operate appropriately under this condition.

### Embodiment 3

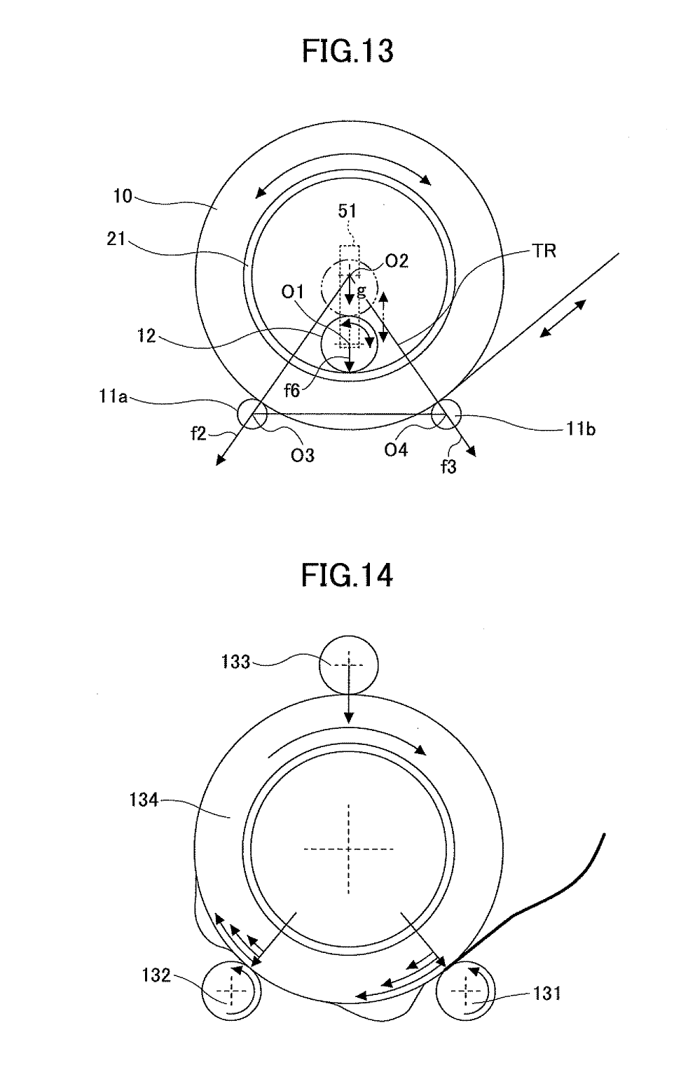

Next, a rolled paper driving apparatus according to an embodiment 3 of the present invention will be described. The rolled paper driving apparatus according to the embodiment 3 is almost the same as the rolled paper driving apparatus according to the embodiment 1 described above, and thus, different points will be described and duplicate description will be appropriately omitted. In the rolled paper driving apparatus according to the embodiment 3, the driving roller 12 is disposed at the center position between the first supporting rollers 11a and the second supporting rollers 11b in the inside of the above-mentioned triangle TR. FIG. 13 diagrammatically shows a position relationship between the driving roller 12 and the first and second supporting rollers 11a and 11b in the rolled paper driving apparatus according to the embodiment 3.

In the rolled paper driving apparatus according to the embodiment 3, as shown in FIG. 13, the driving roller 12 is caused to come into contact with the inner circumferential surface of the core pipe 21 at the center position (when viewed from the top) between the first supporting rollers 11a and the second supporting rollers 11b. The driving roller 12 is mounted on a driving roller driving mechanism 51 that holds the driving roller 12 in such a manner that the driving roller 12 is movable upward and downward. The driving roller driving mechanism 51 moves the driving roller 12 upward and downward, and disposes the driving roller 12 at a position at which the driving roller 12 comes into contact with the inner circumferential surface of the core pipe 21 (indicated by the solid line in FIG. 13) and at a position at which the driving roller 12 is apart upward from the inner circumferential surface of the core pipe 21 (indicated by the dash-dot-dot line in FIG. 13).

The driving roller driving mechanism 51 gives force to the driving roller 12 to press the inner circumferential surface of the core pipe 21 by force f6 in the state that the driving roller 12 is in contact with the inner circumferential surface of the core pipe 21. The driving roller 12 also transmits rotation driving force, transmitted from the driving force transmission mechanism 24 via the torque limiter 26, to the core pipe 21. As the driving roller driving mechanism 51, a well-known mechanism such as a cylinder mechanism that moves the driving roller upward and downward may be used.

According to the embodiment 3, the pressing force f6 of the driving roller 12 is set depending on the operation conditions. Since the driving roller 12 comes into contact with the inner circumferential surface of the core pipe 21 at the center position (when viewed from the top) between the first supporting rollers 11a and the second supporting rollers 11b, the rolled paper 10 does not easily move over the respective ones of the first supporting rollers lie and the second supporting rollers 11b. Therefore, it is possible to set the pressing force f6 to be smaller than the case where the driving roller 12 is disposed near the first supporting rollers 11a or the second supporting rollers 11b. It is noted that the pressing force f6 may be made different between the time of pulling out and the time of winding.

The present invention is not limited to the specifically disclosed embodiments, and variations and modifications may be made without departing from the scope of the present invention.

The present application is based on Japanese priority applications Nos. 2010-060753 and 2010-267550, filed Mar. 17, 2010 and Nov. 30, 2010, the entire contents of which are hereby incorporated herein by reference.

What is claimed is:

1. A rolled paper driving apparatus comprising:
supporting rollers disposed on a base for supporting paper being rolled onto a core pipe in such a manner that an axis line of the rolled paper extends between the supporting rollers;
a driving roller that presses an inner circumferential surface of the core pipe of the rolled paper and gives force to rotate the rolled paper;
a driving force transmission part that rotates the driving roller; and
a pressing force adjustment part that adjusts a state of the driving roller pressing the inner circumferential surface of the core pipe of the rolled paper, wherein
the driving roller is disposed in the inside of a triangle that has vertexes respectively corresponding to the supporting rollers and a center of the rolled paper.

2. The rolled paper driving apparatus as claimed in claim 1, wherein
the driving roller is inserted into the core pipe from one side of an opening portion of the core pipe, and
a pressing roller is provided to be inserted into the core pipe from the other side of the opening portion, come into contact with the inner circumferential surface of the core pipe, and give force to the rolled paper.

3. The rolled paper driving apparatus as claimed in claim 1, further comprising:
a moving part that moves at least one of the driving roller and the pressing roller in directions in which the axis line of the rolled paper extends.

4. The rolled paper driving apparatus as claimed in claim 2, wherein
the pressing force adjustment part includes a force giving part that gives force and a giving force changing mechanism that adjusts the force given by the force giving part and allows the driving roller and the pressing roller to be apart from the core pipe.

5. The rolled paper driving apparatus as claimed in claim 2, wherein
the pressing force adjustment part includes
a force giving part that includes springs provided for the driving roller and the pressing roller, and
a giving force adjustment part that includes cam members that change force to be given by the springs, a shaft member that links the cam members together, and an operation arm that changes attitudes of the cam members.

6. The rolled paper driving apparatus as claimed in claim 4, wherein
the force giving part includes springs provided for the driving roller and the pressing roller, and
the giving force adjustment part includes cam members that change force to be given by the springs, a shaft member that links the cam members and an operation arm that changes attitudes of the cam members.

7. The rolled paper driving apparatus as claimed in claim 2, wherein
the driving roller and the pressing roller are disposed on arm members that are disposed at both end portions of the base, the rolled paper is disposed between the arm members, the arm members are disposed rotatably with respect to the base, and at least one of the arm members is configured to be movable in directions in which the axis line of the rolled paper extends.

8. The rolled paper driving apparatus as claimed in claim 1, further comprising:
a detection part that detects a rotation direction of the rolled paper;
a driving roller position changing part that changes a position at which the driving roller comes into contact with the core pipe within the inside of the triangle; and
a driving roller position control part that drives the driving roller position changing part based on a detection result of the detection part and sets the position at which the driving roller comes into contact with the core pipe to an end portion of the core pipe on a downstream side of the rotation direction of the core pipe in the inside of the triangle.

9. The rolled paper driving apparatus as claimed in claim 1, wherein
a torque limiter is provided between the driving roller and a prime mover that drives the driving roller, and is configured to transmit torque and avoid transmitting torque equal to or more than a predetermined value.

10. An image forming apparatus including the rolled paper driving apparatus claimed in claim 1.
